(19) United States
(12) Patent Application Publication
(10) Pub. No.: US 2019/0037052 A1
(43) Pub. Date: Jan. 31, 2019

(54) SYSTEMS AND METHODS FOR LINK LAYER SIGNALING OF UPPER LAYER INFORMATION

(71) Applicant: Sharp Kabushiki Kaisha, Sakai City, Osaka (JP)

(72) Inventor: Sachin G. DESHPANDE, Camas, WA (US)

(21) Appl. No.: 16/077,495

(22) PCT Filed: Feb. 23, 2017
(86) PCT No.: PCT/JP2017/006856

§ 371 Date: Aug. 13, 2018

Related U.S. Application Data
(60) Provisional application No. 62/298,983, filed on Feb. 23, 2016.

(51) Int. Cl. H04L 29/06; H04L 12/741

(52) U.S. Cl. CPC H04L 69/04; H04L 45/74

(57) ABSTRACT

A device may be configured to transmit data associated with an upper layer session according to one or more link layer packet payload structures. A link layer packet payload structure may include a table.

### TECHNICAL FIELD

The present disclosure relates to the field of interactive television.

### BACKGROUND ART

Digital media playback capabilities may be incorporated into a wide range of devices, including digital televisions, including so-called “smart” televisions, set-top boxes, laptop or desktop computers, tablet computers, digital recording devices, digital media players, video gaming devices, cellular phones, including so-called “smart” phones, dedicated video streaming devices, and the like. Digital media content (e.g., video and/or audio programming, and application based enhancements) may originate from a plurality of sources including, for example, over-the-air television providers, satellite television providers, cable television providers, online media service providers, including, so-called streaming service providers, and the like. Digital media content may be delivered over packet-switched networks, including bidirectional networks, such as Internet Protocol (IP) networks, and unidirectional networks, such as digital broadcast networks.

Digital media content may be transmitted from a source to a receiver device (e.g., a digital television or a smart phone) according to a transmission standard. Examples of transmission standards include Digital Video Broadcasting (DVB) standards, Integrated Services Digital Broadcasting Standards (ISDB) standards, and standards developed by the Advanced Television Systems Committee (ATSC), including, for example, the ATSC 2.0 standard. The ATSC is currently developing the so-called ATSC 3.0 suite of standards. Transmission standards may define mechanisms for encapsulating digital media content for transmission and may define mechanisms for signaling information associated with the transmission of the digital media content. Current techniques for signaling information associated with the transmission of digital media content may be less than ideal.

### SUMMARY OF INVENTION

In general, this disclosure describes techniques for signaling (or signalling) information associated with an upper layer session in a link layer. In particular, this disclosure describes techniques for transmitting data associated with an upper layer session according to one or more link layer packet payload structures. The techniques described herein may enable efficient transmission of data. The techniques described herein may be particular useful for digital media applications. It should be noted that although in some examples the techniques of this disclosure are described with respect to ATSC standards, including those currently under development, the techniques described herein are generally applicable to any transmission standard. For example, the techniques described herein are generally applicable to any of DVB standards, ISDB standards, ATSC Standards, Digital Terrestrial Multimedia Broadcast (DTMB) standards, Digital Multimedia Broadcast (DMB) standards, Hybrid Broadcast and Broadband Television (HbbTV) standard, World Wide Web Consortium (W3C) standards, Universal Plug and Play (UPnP) standards, and other video encoding standards.

According to one example of the disclosure, a method for signaling upper layer information in a link layer packet comprises generating a table including session identifying information respectively associated with one or more physical layer pipes, wherein the table indicates whether the table includes session identifying information for physical layer pipes associated with possible values of a physical layer pipe identifier, and transmitting the table to one or more receiver devices.

According to another example of the disclosure, a device for signaling upper layer information in a link layer packet comprises one or more processors configured to generate a table including session identifying information respectively associated with one or more physical layer pipes, wherein the table indicates whether the table includes session identifying information for physical layer pipes associated with possible values of a physical layer pipe identifier, and transmit the table to one or more receiver devices.

According to another example of the disclosure, an apparatus for signaling upper layer information in a link layer packet comprises means for generating a table including session identifying information respectively associated with one or more physical layer pipes, wherein the table indicates whether the table includes session identifying information for physical layer pipes associated with possible values of a physical layer pipe identifier, and means for transmitting the table to one or more receiver devices.

According to another example of the disclosure, a non-transitory computer-readable storage medium comprises instructions stored thereon that upon execution cause one or more processors of a device to generate a table including session identifying information respectively associated with one or more physical layer pipes, wherein the table indicates whether the table includes session identifying information for physical layer pipes associated with possible values of a physical layer pipe identifier, and transmit the table to one or more receiver devices.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example of content delivery protocol model according to one or more techniques of this disclosure.

FIG. 2A is a conceptual diagram illustrating an example of a link layer packet structure according to one or more techniques of this disclosure.

FIG. 2B is a conceptual diagram illustrating an example of a link layer packet structure for a signaling packet according to one or more techniques of this disclosure.

FIG. 3 is a block diagram illustrating an example of a system that may implement one or more techniques of this disclosure.

FIG. 4 is a block diagram illustrating an example of a service distribution engine that may implement one or more techniques of this disclosure.

FIG. 5 is a block diagram illustrating an example of a link layer packet generator that may implement one or more techniques of this disclosure.

FIG. 6 is a conceptual diagram illustrating an example of generating a signal for distribution over a communication network according to one or more techniques of this disclosure.

FIG. 7 is a block diagram illustrating an example of a receiver device that may implement one or more techniques of this disclosure.

### DESCRIPTION OF EMBODIMENTS

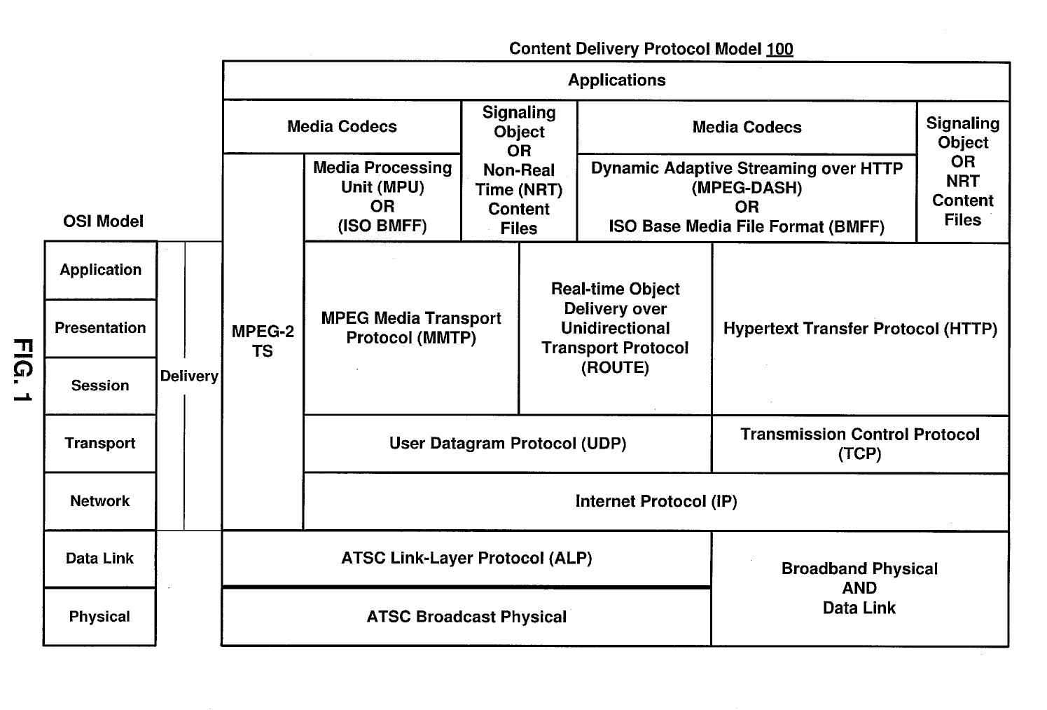

Computing devices and/or transmission systems may be based on models including one or more abstraction layers, where data at each abstraction layer is represented according to particular structures, e.g., packet structures, modulation schemes, etc. An example of a model including defined abstraction layers is the so-called Open Systems Interconnection (OSI) model illustrated in FIG. 1. The OSI model defines a 7-layer stack model, including an application layer, a presentation layer, a session layer, a transport layer, a network layer, a data link layer, and a physical layer. It should be noted that the use of the terms upper and lower with respect to describing the layers in a stack model may be based on the application layer being the uppermost layer and the physical layer being the lowermost layer. Further, in some cases, the term “Layer 1” or “L1” may be used to refer to a physical layer, the term “Layer 2” or “L2” may be used to refer to a link layer, and the term “Layer 3” or “L3” or “IP layer” may be used to refer to the network layer.

A physical layer may generally refer to a layer at which electrical signals form digital data. For example, a physical layer may refer to a layer that defines how modulated radio frequency (RF) symbols form a frame of digital data. A data link layer, which may also be referred to as link layer, may refer to an abstraction used prior to physical layer processing at a sending side and after physical layer reception at a receiving side. As used herein, a link layer may refer to an abstraction used to transport data from a network layer to a physical layer at a sending side and to transport data from a physical layer to a network layer at a receiving side. It should be noted that a sending side and a receiving side are logical roles and a single device may operate as both a sending side in one instance and as a receiving side in another instance. As described in further detail below, a link layer may abstract various types of data (e.g., video, audio, or application files) encapsulated in particular packet types (e.g., Motion Picture Expert Group-Transport Stream (MPEG-TS) packets, Internet Protocol Version 4 (IPv4) packets, etc.) into a single generic format for processing by a physical layer. A network layer may generally refer to a layer at which logical addressing occurs. That is, a network layer may generally provide addressing information (e.g., Internet Protocol (IP) addresses) such that data packets can be delivered to a particular node (e.g., a computing device) within a network. As used herein the term network layer may refer to a layer above a link layer and/or a layer having data in a structure such that it may be received for link layer processing. Each of a transport layer, a session layer, a presentation layer, and an application layer may define how data is delivered for use by a user application.

Transmission standards, including transmission standards currently under development, may include a content delivery protocol model specifying supported protocols for each layer and may further define one or more specific layer implementations. Referring again to FIG. 1, an example content delivery protocol model is illustrated. In the example illustrated in FIG. 1, content delivery protocol model 100 is “aligned” with the 7-layer OSI model for illustration purposes. It should be noted that such an illustration should not be construed to limit implementations of the content delivery protocol model 100 or the techniques described herein. Content delivery protocol model 100 may generally correspond to the currently proposed content delivery protocol model for the ATSC 3.0 suite of standards. Further, the techniques described herein may be implemented in a system configured to operate based on content delivery protocol model 100.

Aspects of the ATSC 3.0 suite of standards currently under development are described in Candidate Standards, which may include proposed aspects for inclusion in a published (i.e., “final” or “adopted”) version of an ATSC 3.0 standard. For example, ATSC Candidate Standard: System Discovery and Signaling, Doc. 532-230r21, 28 Sep. 2015, which is incorporated by reference in its entirety, describes specific proposed aspects of an ATSC 3.0 unidirectional physical layer implementation. The proposed ATSC 3.0 unidirectional physical layer includes a physical layer frame structure including a defined bootstrap, preamble, and data payload structure including one or more physical layer pipes (PLPs). A PLP may generally refer to a logical structure within an RF channel or a portion of an RF channel. That is, a PLP may include a portion of an RF channel having particular modulation and coding parameters. The proposed ATSC 3.0 unidirectional physical layer provides that a single RF channel can contain one or more PLPs and each PLP may carry one or more services (e.g., a video service, an audio service, and/or a close caption service). Referring to FIG. 1, content delivery protocol model 100 supports streaming and/or file download through the ATSC Broadcast Physical layer using MPEG Media Transport Protocol (MMTP) over User Datagram Protocol (UDP) and Internet Protocol (IP) and Real-time Object delivery over Unidirectional Transport (ROUTE) over UDP and IP. MMTP is described in ISO/IEC: ISO/IEC 23008-1, “Information technology-High efficiency coding and media delivery in heterogeneous environments-Part 1: MPEG media transport (MMT),” which is incorporated by reference herein in its entirety. An overview of ROUTE is provided in ATSC Candidate Standard: Signaling, Delivery, Synchronization, and Error Protection (A/331) Doc. 532-174r1, 5 Jan. 2016 (hereinafter “A/331”), which is incorporated by reference in its entirety. It should be noted that although ATSC 3.0 uses the term “broadcast” to refer to a unidirectional over-the-air transmission physical layer, the so-called ATSC 3.0 broadcast physical layer supports video delivery through streaming or file download. As such, the term broadcast as used herein should not be used to limit the manner in which video and associated data may be transported according to one or more techniques of this disclosure.

In the case where MMTP is used for streaming and/or file download through the ATSC Broadcast Physical layer, service component data (e.g., video data, audio data, closed caption data, etc.) may be encapsulated in a Media Processing Unit (MPU). MMTP defines a MPU as “a media data item that may be processed by an MMT entity and consumed by the presentation engine independently from other MPUs.” A logical grouping of MPUs may form an MMT asset, where MMTP defines an asset as “any multimedia data to be used for building a multimedia presentation. An asset is a logical grouping of MPUs that share the same asset identifier for carrying encoded media data.” For example, for a video component, MPUs may include groups of pictures (GOPs) that are independently decodable and an asset may include several MPUs forming a video sequence. One or more assets may form a MMT package, where a MMT package is a logical collection of multimedia content. For example, an MMT package may include an asset corresponding to a video component and an asset corresponding to an audio component. A/331 provides that a single MMT package can be delivered over one or more MMTP sessions, where each MMTP session can be identified by a destination IP address and a destination UDP port number. Further, A/331 provides that multiple MMT packages can be delivered by a single MMTP session. A/331 provides that each PLP can carry one or more MMTP sessions. In addition, A/331 provides that one MMTP session can be carried by more than one PLP.

In the case where ROUTE is used for streaming and/or file download through the ATSC Broadcast Physical layer, service component data may be associated with one or more Layer Coding Transport (LCT) channels. In some cases, an LCT channel may be conceptually similar to an MMT asset. That is, for media delivery, an LCT channel may carry as a whole, or in part, a media component and a ROUTE session may be considered as the multiplex of LCT channels that carry constituent media components of one or more media presentations. That is, each ROUTE session may include one or more LCT channels, where LCT channels are subsets of a ROUTE session. Further, A/331 provides that one or more LCT channels may be included in a PLP and as such, a ROUTE session may be carried by one or more PLPs. Further, similar to a MMTP session, A/331 provides that a ROUTE session may be identified by a destination IP address and a destination UDP port number. It should be noted that a ROUTE session may further be identified by a source IP address.

Each of a MMTP session and a ROUTE session may be referred to as upper layer sessions. As used herein the term upper layer session may generally refer to data associated with a network address and at least one higher layer address. In some cases, the term upper layer session may more particularly refer to a destination IP address and a destination port number associated with a service component. Further, it should be that in some cases a type of upper layer session may be identified based on a type of network protocol and a type of a higher layer protocol. For example, an upper layer session requiring an IPv4 and a UDP port number may be referred to as an IPv4/UDP session. In the case where an upper layer session refers to a destination IP address and a destination UDP port number associated with a service component and is carried by one or more PLPs, in order to join a session (e.g., receive a service component), a receiver device may obtain session identifying information, which may include, at least, identifiers of one or more PLPs, a destination IP address, and a destination UDP port number. It should be noted, that in some cases, additional information may be required to join a session. In some cases, it may be useful for a receiver device to be able to obtain session identifying information through link layer signaling.

A proposed link layer implementation for ATSC 3.0 is described in ATSC Candidate Standard: Link-Layer Protocol (A/330), Doc. 533-169r2, 25 Dec. 2015 (hereinafter “A/330”), which is incorporated by reference in its entirety. The proposed link layer, which may be referred to as ATSC Link-layer Protocol (ALP), abstracts various types of data encapsulated in particular packet types (e.g., MPEG transport stream (MPEG-TS) packets, Internet Protocol (IP) packets, signaling packets, extension packets, etc.) into a single generic format for processing by the physical layer. It should be noted that in one example, an MPEG-TS may be defined as a standard container format for transmission and storage of audio, video, and Program and System Information Protocol (PSIP) data. The ATSC 3.0 proposed link layer supports segmentation of a single upper layer packet into multiple link layer packets and concatenation of multiple upper layer packets into a single link layer packet. Further, the ATSC 3.0 proposed link layer supports compression of network packets and link layer signaling of upper layer information.

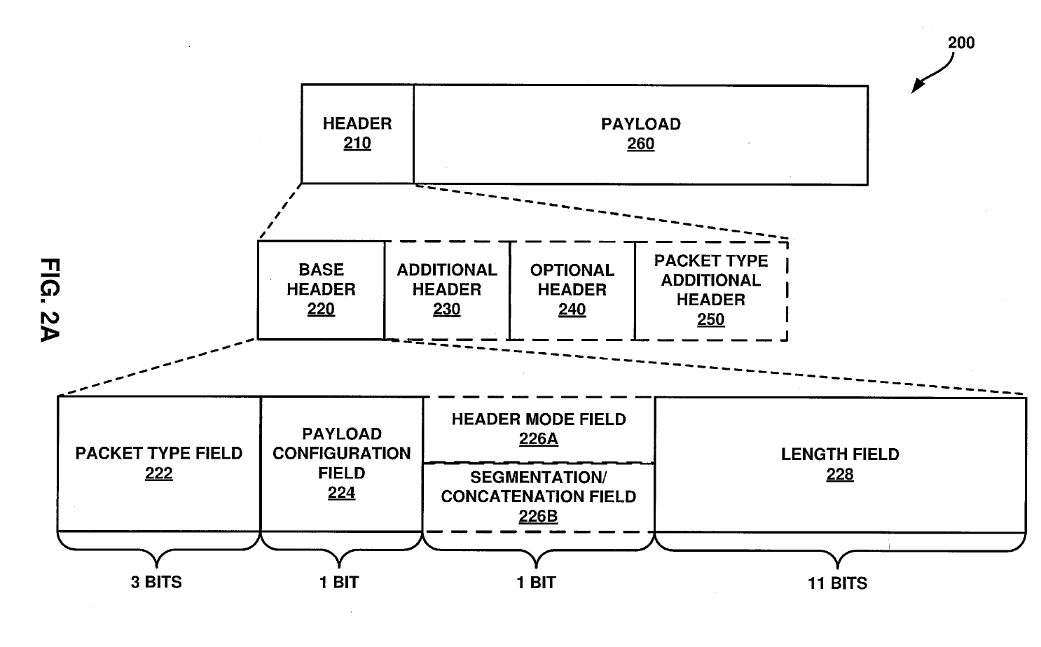

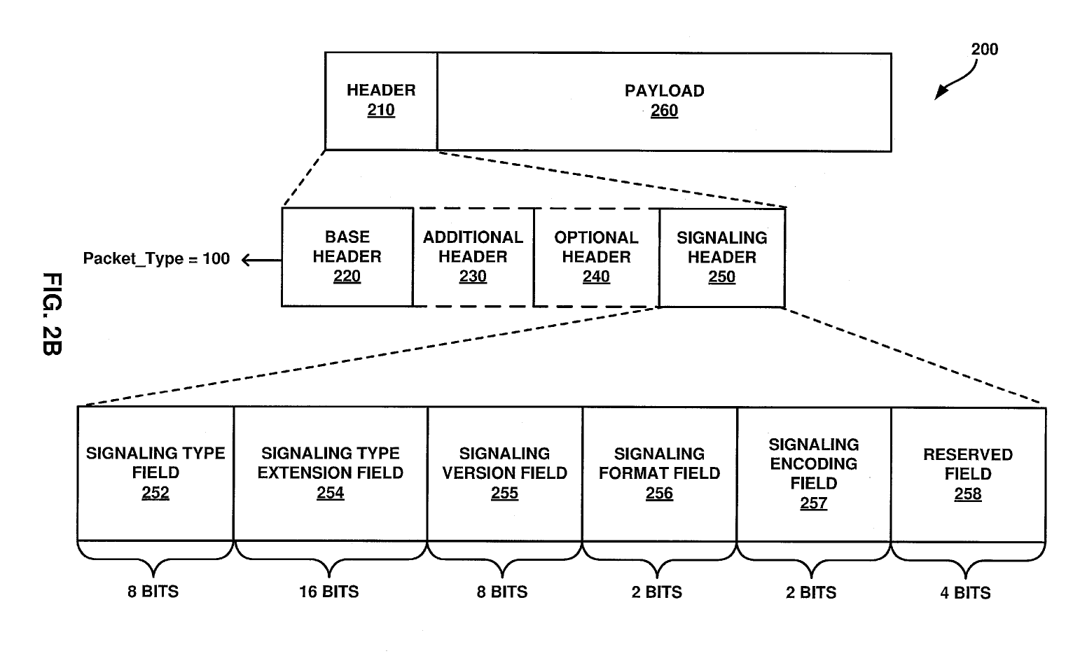

FIG. 2A is a conceptual diagram illustrating an example of a link layer packet structure according to one or more techniques of this disclosure. As illustrated in FIG. 2A, packet structure 200 includes header 210 and payload 260. Header 210 may provide information identifying a type of data encapsulated within payload 260 and how the data is encapsulated within payload 260. For example, header 210 may include a field that indicates that payload 260 encapsulates a particular type of network packet. Further, header 210 may include a field that indicates link layer packets are used to provide link layer signaling. As described above, data encapsulated within payload 260 may be compressed. For example, in the case where network layer packets include MPEG-2 TS packets, multiple MPEG-2 TS packets may be encapsulated within payload 260 and a sync byte present in each MPEG-2 TS packet may be deleted, MPEG-2 TS NULL packets included in a data stream may be deleted, and/or common MPEG-2 TS headers may be deleted. Further, in the case where network layer packets include IP packets, headers of IP packets may be compressed.

In the example illustrated in FIG. 2A, base header 220 is two bytes in length and may be the minimum length of header 210. As described in detail below, in one example, base header 220 may indicate one of four types of packet configurations: a single packet without any additional headers, a single packet with an additional header, a segmented packet, and a concatenated packet. In the example illustrated in FIG. 2A, header 210 includes base header 220, and optionally includes, additional header 230, optional header 240, and packet type additional header 250. In one example, the presence of additional header 230 may be dependent on control fields included in base header 220, and the inclusion of optional header 240 may be indicated from flag fields included in additional header 230 if present. The presence of packet type additional header 250 may be dependent on a packet type field 222 in base header 220. For example, as described below with respect to FIG. 2B, when packet type field 222 indicates a signaling packet, header 210 includes a signaling header 250 as part of packet type additional header. It should be noted that in other examples, the presence of one or more of additional header 230, optional header 240, and packet type additional header 250 may be based on other logical relationships.

In the example illustrated in FIG. 2A, base header 220 includes packet type field 222, payload configuration (PC) field 224, one of header mode (HM) field 226A or segmentation/concatenation (S/C) field 226B and length field 228. In the example illustrated in FIG. 2A, a length (e.g., a length in bits) is provided for each of packet type field 222, payload configuration field 224, one of header mode field 226A or segmentation/concatenation field 226B, and length field 228. It should be noted that in other examples the fields may have other bit lengths. For example, instead of 11 bits for length field 228, 4 bits, 8 bits, or another number of bits may be used and the number of bits used for other fields may be modified accordingly and/or additional fields may be added to base header 210. It should be noted that in some examples, the fields may be referenced using other names and still have the same role or semantics. For example “Additional Header” may in some examples, be referred to as “aph header” or “addl header.”

Packet type field 222 may identify a type of network packet encapsulated within payload 260. In one example, packet type field 222 may include a 3-bit packet_type syntax element that indicates the original protocol or packet type of the input data before encapsulation into a link layer packet. An example of how values of packet_type may indicate an original protocol or a packet type is illustrated in Table 1.

TABLE 1

| packet_type Value | Meaning |
|---|---|
| 000 | IPv4 packet |
| 001 | Reserved |
| 010 | Compressed IP packet |
| 011 | Reserved |
| 100 | Link layer signaling packet |
| 101 | Reserved |
| 110 | Packet Type Extension |
| 111 | MPEG-2 Transport Stream |

Payload configuration field 224 may indicate whether header mode field 226A or segmentation/concatenation field 226B is present in base header 220. In one example, payload configuration field 224 may include a 1-bit payload_configuration syntax element indicating the configuration of the payload. In one example, a value of ‘0’ may indicate that the link layer packet carries a single, whole input packet and the following field is header mode field and a value of ‘1’ may indicates that the packet carries more than one input packet (concatenation) or a part of a large input packet (segmentation) and the following field is segmentation/concatenation field. When present, header mode field 226A may indicate whether additional header 230 is present and the length of the link layer packet. In one example, a 1-bit header_mode syntax element may indicate there is no additional header and that the length of the payload of the link layer packet is less than 2048 bytes (e.g., when set to ‘0’) or indicate that an additional header for single packet is present following length field 228 (e.g., when set to ‘1’). In the case where header_mode indicates that an additional header for single packet is present, the length of the payload may be larger than 2047 bytes and/or optional features may be used (sub-stream identification, header extension, etc.). When present, segmentation/concatenation field 226B may indicate whether a link layer packet is a segment of a network layer packet or whether several network layer packets are concatenated within the link layer packet. In one example, a 1-bit segmentation_concatenation syntax element may indicate that the payload carries a segment of an input packet and an additional header for segmentation is present following length field 228 (e.g., when set to ‘0’) or indicate that the payload carries more than one complete input packet and an additional header for concatenation is present is following length field 228 (e.g., when set to ‘0’). Length field 228 may indicate the total length of payload 260. In one example, length field 228 may include an 11-bit length syntax element indicating the 11 least significant bits (LSBs) of the length in bytes of payload carried by the link layer packet. It should be noted that in some cases, length field 228 may be concatenated with fields following additional header 230 to provide the actual total length of the payload.

An example syntax that may be used for packet structure 200 including the example syntax element described above is illustrated in Table 2. In Table 2, as well as in other tables below, uimsbf may refer to an unsigned integer, transmitted most significant bit first, and bslbf may refer bit string, left bit first. It should be noted that in other examples, different data types may be used for an element in any of the Tables described herein. For example instead of an unsigned integer data type an unsigned byte data type, or the like, may be used. Further, instead of signaling data as syntactic elements, data may be signaled using as an attribute, where an attribute general refers to a data value that provides more information about an element. Further, the cardinality of an element is not limited to the values illustrated in the example tables below.

With respect to Table 2, it should be noted that for the sake of brevity a complete description of the respective formats of additional_header_for_single_packet( ), additional_header_for_segmentation( ), additional_header_for_concatenation( ), and additional_header_for_type_extension( ) is not provided herein. However, as illustrated in Table 2, reference is made to sections of A/330 for example formats of additional_header_for_single_packet( ), additional_header_for_segmentation( ), additional_header_for_concatenation( ), and additional_header_for_type_extension( ). An example format of additional_header_for_signaling_information( ) is described below with respect to Table 6.

TABLE 2

| | | |
|---|---|---|
| | Number of | |
| Syntax | bits | Format |

Link_layer_Packet_Header( ) {

| | | |
|---|---|---|
| packet_type | 3 | uimsbf |
| payload_configuration | 1 | bslbf |
| if (payload_configuration == “0”) { | | |

| | | |
|---|---|---|
| header_mode | 1 | bslbf |
| length | 11 | uimsbf |
| if (header_mode == “1”) { | | |

| | | |
|---|---|---|
| additional_header_for_single_packet( ) | variable | Table 5.4 in A/330 |

}

}
else if (payload_configuration == “1”){

| | | |
|---|---|---|
| segmentation_concatenation | 1 | bslbf |
| length | 11 | uimsbf |
| if (segmentation_concatenation == “0”) { | | |

| | | |
|---|---|---|
| additional_header_for_segmentation( ) | variable | Table 5.5 in A/330 |

}
else if (segmentation_concatenation == “1”) {

| | | |
|---|---|---|
| additional_header_for_concatenation( ) | variable | Table 5.6 in A/330 |

}

}
if(packet_type== ‘100’) {

| | | |
|---|---|---|
| additional_header_for_signaling_information( ) | variable | Table 6 |

}
else if(packet_type== ‘110’) {

| | | |
|---|---|---|
| additional_header_for_type_extension( ) | 16 | Table 5.14 in A.330 |

}

}

As described above, signaling packets may be used to provide link layer signaling. Referring to the examples illustrated in Table 1 and Table 2, signaling packets may be identified by packet_type syntax element in base header 220 being equal to ‘100’. FIG. 2B illustrates an example of a signaling packet additional header. As illustrated in FIG. 2B, signaling packet additional header includes signaling type field 252, signaling type extension field 254, signaling version field 255, signaling format field 256, signaling encoding field 257, and reserved field 258. In the example illustrated in FIG. 2B, a length is provided for each of signaling type field 252, signaling type extension field 254, signaling version field 255, signaling format field 256, signaling encoding field 257, and reserved field 258. It should be noted that in other examples these fields may have other bit lengths.

Signaling type field 252 may indicate a type of signaling. In one example, signaling type field 252 may include an 8-bit signaling_type syntax element that indicates a signaling type based on Table 3. As described above, in some cases, it may be useful for a receiver device to be able to obtain session identifying information through link layer signaling. Link Mapping Table (LMT) (indicated by signaling_type 0x01 in Table 3) may provide session identifying information. Examples of LMTs are described in further detail below. Further, the techniques described herein may enable a receiver device to obtain session identifying information from a link mapping table in an efficient manner. Further, it should be noted with respect to Table 3, ROHC-U may refer to a unidirectional mode robust header compression (ROHC). Aspects of an example ROHC are provided in A/330. In A/330, ROHC refers to an IP header compression technique and includes two parts: header compressor/decompressor and adaption module. At the transmitter side, an adaptation module extracts context information and builds signaling information from each packet stream and at the receiver side, an adaptation module parses the signaling information associated with the received packet stream and attaches context information to the received packet stream.

TABLE 3

| signaling_type | Meaning |
|---|---|
| 0x00 | Reserved |
| 0x01 | Link Mapping Table |
| 0x02 | ROHC-U Configuration Table |
| 0x03-0xFF | Reserved |

Referring again to FIG. 2B, signaling type extension field 254 may indicate an attribute of signaling. In one example, signaling type extension field 254 may include a 16-bit signaling_type_extension syntax element that indicates the attribute of the signaling. In one example, signaling_type_extension may be defined within a signaling table. Signaling version field 255 may indicate a version of signaling. For example, signaling version field 225 may be used to indicate whether a Link Mapping Table has been updated in a subsequent transmission. In one example, signaling version field 255 may include an 8-bit signaling_version syntax element that indicates a version of signaling. Signaling format field 256 may indicate a format of signaling data. In one example, signaling format field 256 may include a 2-bit signaling_format syntax element that indicates a signaling format based on Table 4. It should be noted in Table 4, XML refers to Extensible Markup Language (XML), and JSON refers to JavaScript Object Notation (JSON). Further, it should be noted that in other examples, values 00, 01, 10 and 11 may indicate other data formats than those illustrated in Table 4. For example, each of 00, 01, 10 and 11 may respectively correspond to one of: Binary, XML, JSON, Hypertext Markup Language (HTML), Comma Separated Values (CSV), Backus-Naur Form (BNF), Augmented Backus-Naur Form (ABNF), and Extended Backus-Naur Form (EBNF). Further, it should be noted that in one example, value 11 may indicate that reserved field 258 indicates a data format.

TABLE 4

| signaling_format | Meaning |
|---|---|
| 00 | Binary |
| 01 | XML |
| 10 | JSON |
| 11 | Reserved |

Signaling encoding field 257 may indicate an encoding/compression format of signaling data. In one example, signaling encoding field 257 may include a 2-bit signaling_encoding syntax element that indicates a encoding/compression format based on Table 5. With respect to Table 5, RFC refers to a Request for Comments (RFC) published by the Internet Engineering Task Force (IETF). For example, RFC 1951 refers to DEFLATE Compressed Data Format Specification version 1.3 May 1996. It should be noted that in other examples, values 00, 01, 10 and 11 may indicate other signal encodings than those illustrated in Table 5. For example, each of 00, 01, 10 and 11 may respectively correspond to one of: No compression, DEFLATE, GZIP (RFC 1952), adaptive Lempel-Ziv-Welch coding (LZW), or other types of lossless data compression algorithms (Context-adaptive binary arithmetic coding (CABAC), Context-adaptive variable-length coding (CAVLC), etc.).

TABLE 5

| signaling_encoding | Number of bits |
|---|---|
| 00 | No Compression |
| 01 | DEFLATE (RFC 1951) |
| 10 | Reserved |
| 11 | Reserved |

An example bit stream syntax of an additional_header_for_signaling_information( ) is illustrated in Table 6.

TABLE 6

| | | |
|---|---|---|
| | Number of | |
| Syntax | bits | Mnemonic |

additional_Header_for_Signaling_Information( ) {

| | | |
|---|---|---|
| signaling_type | 8 | uimsbf |
| signaling_type_extension | 16 | bslbf |
| signaling_version | 8 | uimsbf |
| signaling_format | 2 | uimsbf |
| signaling_encoding | 2 | uimsbf |
| reserved | 4 | bslbf |

}

As described above, with respect to Table 3, LMTs may provide session identifying information. That is, a LMT may provide a list of upper layer sessions carried in a PLP. The currently proposed version of the ATSC 3.0 suite of standards provides an example syntax for an LMT. The example LMT syntax provided in the currently proposed version of the ATSC 3.0 suite of standards (described in A/330) is illustrated in Table 7A.

TABLE 7A

| | | |
|---|---|---|
| | No. of | |
| Syntax | bits | Format |

link_mappmg_table( ) {

| | | |
|---|---|---|
| signaling_type | 8 | |
| PLP_ID | 6 | uimsbf |
| reserved | 2 | ‘11’ |
| num_session | 8 | uimsbf |
| for(j=0; j<num_session; j++) { | | |

| | | |
|---|---|---|
| src_IP_add | 32 | uimsbf |
| dst_IP_add | 32 | uimsbf |
| src_UDP_port | 16 | uimsbf |
| dst_UDP_port | 16 | uimsbf |
| SID_flag | 1 | bslbf |
| compressed_flag | 1 | bslbf |
| reserved | 6 | ‘111111’ |
| if (SID_flag ==″1″) { | | |

| | | |
|---|---|---|
| SID | 8 | uimsbf |

}
if (compressed_flag == “1”) {

| | | |
|---|---|---|
| context_id | 8 | uimsbf |

}

}

}

Definitions of syntax elements, signaling_type, PLP_ID, num_session, src_IP_add, dst_IP_add, src_UDP_port, dst_UDP_port, SID_flag, compressed_flag, SID, and context_id in Table 7A, as provided in A/330 are provided below:
signaling_type—This 8-bit unsigned integer field shall indicate the type of signaling carried by this table. The value of the signaling_type field for the LMT shall be set to ‘0x01’.
PLP_ID—This 6-bit field shall indicate the PLP corresponding to this table.
num_session—This 8-bit unsigned integer field shall provide the number of upper layer sessions carried in the PLP identified by the above PLP_ID. When the value of signaling_type field is ‘0x01’, this field shall indicate the number of UDP/IPv4 sessions in the PLP.
sre_IP_add—This 32-bit unsigned integer field shall contain the source IPv4 address of an upper layer session carried in the PLP identified by the PLP_ID field.
dst_IP_add—This 32-bit unsigned integer field shall contain the destination IPv4 address of an upper layer session carried in the PLP identified by the PLP_ID field.
src_UDP_port—This 16-bit unsigned integer field shall represent the source UDP port number of an upper layer session carried in the PLP identified by the PLP_ID field.
dst_UDP_port—This 16-bit unsigned integer field shall represent the destination UDP port number of an upper layer session carried in the PLP identified by the PLP_ID field.
SID_flag—This 1-bit Boolean field shall indicate whether the ALP packet carrying the upper layer session identified by the above four fields, sre_ip_add, dst_ip_add, srcudp_port and dst_udp_port, has an SID [i.e., a sub-stream identifier] field in its optional header. When the value of this field is set to ‘0’, the ALP packet carrying the upper layer session shall not have an SID field in its optional header. When the value of this field is set to ‘1’, the ALP packet carrying the upper layer session shall have an SID field in its optional header and the value the SID field shall be same as the following SID field in this table.
compressed_flag—This 1-bit Boolean field shall indicate whether the header compression is applied to the ALP packets carrying the upper layer session identified by the four fields above, src_ip_add, dst_ip_add, src_udp_port and dst_udp_port. When the value of this field is set to ‘0’, the ALP packet carrying the upper layer session shall have a value of ‘0x00’ of packet_type field in its base header. When the value of this field is set to 1, the ALP packet carrying the upper layer session shall have a value of ‘0x02’ in the packet_type field in its base header and the context_id field shall be present.
SID—This 8-bit unsigned integer field shall indicate a sub-stream identifier for the ALP packets carrying the upper layer session identified by the above four fields, src_ip_add, dst_ip_add, src_udp_port and dst_udp_port. This field shall be present only when the value of SID_flag is equal to ‘1’.
context_id—This 8-bit unsigned integer field shall provide a reference for the context_id (CID) provided in the ROHC-U description table as specified in Section 7.1.2 [of A/330]. This field shall be present only when the value of compressed_flag is equal to ‘1’.

It should be noted with respect to Table 7A, a 6-bit identifier (i.e., PLP_ID) is used to identify a particular PLP associated with the LMT. In this case, if a receiver device is attempting to obtain session identifying information for a particular PLP from a LMT, the receiver device may parse PLP_ID and determine if the value of PLP_ID matches the value of the PLP_ID for the particular. Matching the value of a PLP_ID to the value of a particular PLP_ID value to determine if an LMT includes information for a particular PLP may be less than ideal. Further, example LMT syntax that includes session identifying information for multiple PLPs has been proposed. Table 7B provides a summary one example LMT syntax.

TABLE 7B

| | | |
|---|---|---|
| | No. of | |
| Syntax | bits | Format |

link_mapping_table( ) {

| | | |
|---|---|---|
| signaling_type | 8 | |
| num_PLPs | 6 | uimsbf |
| reserved | 2 | ‘11’ |
| for(i=0;i<num_PLPs;i++) { | | |

| | | |
|---|---|---|
| PLP_ID | 6 | uimsbf |
| reserved | 2 | ‘11’ |

| | | |
|---|---|---|
| num_session | 8 | uimsbf |
| for(j=0; j<num_ session; j++) { | | |

| | |
|---|---|
| .... | See Table |

7A

}
if (compressed_flag == “1”)

{

| | | |
|---|---|---|
| context_id | 8 | uimsbf |

}

}

}

The example illustrated in Table 7B includes all of the syntax elements described above with respect to Table 7A. Further, in the example illustrated in Table 7B syntax element num_PLPs indicates the number of PLPs for which the LMT includes session identifying information. In the example illustrated in Table 7B, PLP_ID identifies particular PLPs for which the LMT includes session identifying information. It should be noted that in the example illustrated in Table 7B, if the LMT includes session identifying information for 10 PLPs, 6 bits are used to signal the number of PLPs and 80 bits (10×(6-bit PLP_ID+2 reserved bits for each PLP for byte alignment)) are used to identify particular PLPs. The techniques described herein that may increase transmission efficiency of signaling upper layer session information in link layer signaling. Increasing transmission efficiency may result in significant cost savings for network operators. It should be noted that although the example link layer abstraction techniques described herein are described with respect to a particular example physical layer, the techniques described herein are general applicable regardless of a particular physical layer implementation.

In one example, with respect to Table 7B, semantics of context_id may be modified based on the following definitions:
context_id—This 8-bit unsigned integer field shall provide a reference for the context id (CID) provided in the ROHC-U description table as specified in Section 7.1.2 [of A/330] with value of PLP_ID field in the ROHC-U_description_table( ) equal to PLP_ID. This field shall be present only when the value of compressed_flag is equal to ‘1’.
When compressed_flag is equal to “1” there shall be a ROHC-U_description_table( ) signaled which has PLP_ID value equal to the PLP_ID value equal to PLP_ID.
context_id—This 8-bit unsigned integer field shall provide a reference for the context id (CID) provided in the ROHC-U description table with value of PLP_ID field in the ROHC-U_description_table( ) equal to PLP_ID which carries this link mapping table. This field shall be present only when the value of compressed_flag is equal to ‘1’. In this case the PLP_ID value of the PLP carrying this LMT is used for association to ROHC-U_description_table( ).

In one example, with respect to Table 7B a constraint may be put on syntax element num_PLPs such that num_PLPs shall not be equal to 0. It should be noted that this constraint may be useful because in the case that there are no IP sessions on a particular PLP, it may be more bit-efficient to not include that PLP_ID in the list of PLPs as opposed to including the PLP_ID and indicating that there are no IP sessions for that PLP. Further, in one example, the number of PLPs for which link mapping information is provided in the LMT may be signaled using a syntax element that provides a value that is one greater than the number of PLPs for which link mapping information is provided (i.e., minus 1 coding may be used, e.g., a syntax element num_PLPs_minus1 may be used).

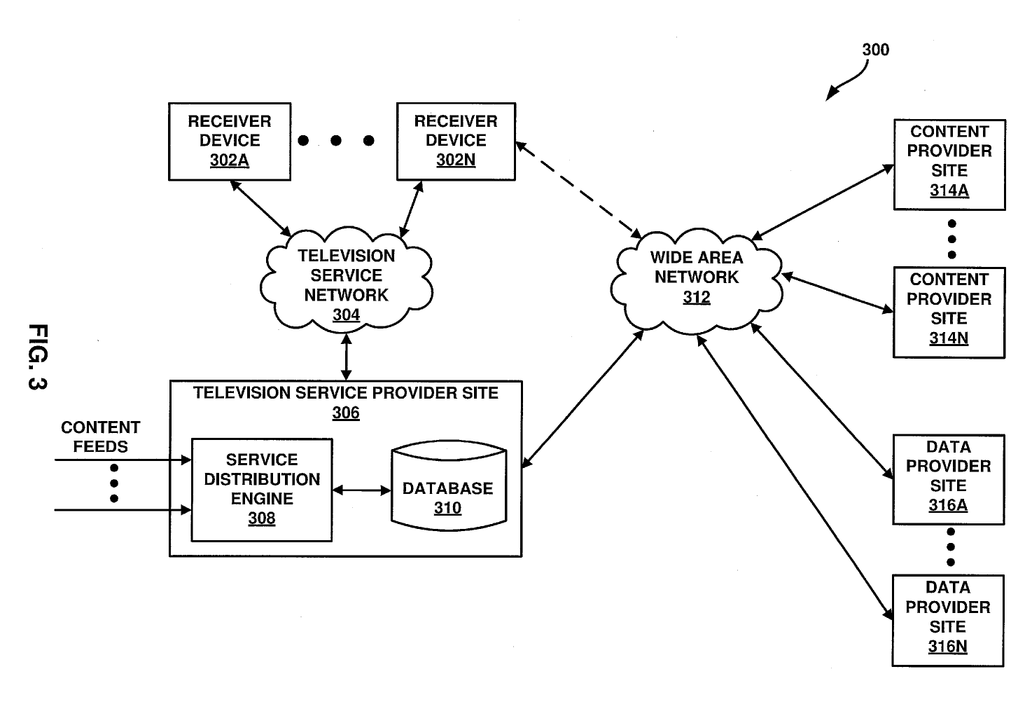

FIG. 3 is a block diagram illustrating an example of a system that may implement one or more techniques described in this disclosure. System 300 may be configured to communicate data in accordance with the techniques described herein. In the example illustrated in FIG. 3, system 300 includes one or more receiver devices 302A-302N, television service network 304, television service provider site 306, wide area network 312, one or more content provider sites 314A-314N, and one or more data provider sites 316A-316N. System 300 may include software modules. Software modules may be stored in a memory and executed by a processor. System 300 may include one or more processors and a plurality of internal and/or external memory devices. Examples of memory devices include file servers, file transfer protocol (FTP) servers, network attached storage (NAS) devices, local disk drives, or any other type of device or storage medium capable of storing data. Storage media may include Blu-ray discs, DVDs, CD-ROMs, magnetic disks, flash memory, or any other suitable digital storage media. When the techniques described herein are implemented partially in software, a device may store instructions for the software in a suitable, non-transitory computer-readable medium and execute the instructions in hardware using one or more processors.

System 300 represents an example of a system that may be configured to allow digital media content, such as, for example, a movie, a live sporting event, etc., and data and applications and multimedia presentations associated therewith (e.g., caption services), to be distributed to and accessed by a plurality of computing devices, such as receiver devices 302A-302N. In the example illustrated in FIG. 3, receiver devices 302A-302N may include any device configured to receive data from television service provider site 306. For example, receiver devices 302A-302N may be equipped for wired and/or wireless communications and may include televisions, including so-called smart televisions, set top boxes, and digital video recorders. Further, receiver devices 302A-302N may include desktop, laptop, or tablet computers, gaming consoles, mobile devices, including, for example, “smart” phones, cellular telephones, and personal gaming devices configured to receive data from television service provider site 306. It should be noted that although system 300 is illustrated as having distinct sites, such an illustration is for descriptive purposes and does not limit system 300 to a particular physical architecture. Functions of system 300 and sites included therein may be realized using any combination of hardware, firmware and/or software implementations.

Television service network 304 is an example of a network configured to enable digital media content, which may include television services, to be distributed. For example, television service network 304 may include public over-the-air television networks, public or subscription-based satellite television service provider networks, and public or subscription-based cable television provider networks and/or over the top or Internet service providers. It should be noted that although in some examples television service network 304 may primarily be used to enable television services to be provided, television service network 304 may also enable other types of data and services to be provided according to any combination of the telecommunication protocols described herein. Further, it should be noted that in some examples, television service network 304 may enable two-way communications between television service provider site 306 and one or more of receiver devices 302A-302N. Television service network 304 may comprise any combination of wireless and/or wired communication media. Television service network 304 may include coaxial cables, fiber optic cables, twisted pair cables, wireless transmitters and receivers, routers, switches, repeaters, base stations, or any other equipment that may be useful to facilitate communications between various devices and sites. Television service network 304 may operate according to a combination of one or more telecommunication protocols. Telecommunications protocols may include proprietary aspects and/or may include standardized telecommunication protocols. Examples of standardized telecommunications protocols include DVB standards, ATSC standards, ISDB standards, DTMB standards, DMB standards, Data Over Cable Service Interface Specification (DOCSIS) standards, HbbTV standards, W3C standards, and UPnP standards.

Referring again to FIG. 3, television service provider site 306 may be configured to distribute television service via television service network 304. For example, television service provider site 306 may include one or more broadcast stations, a cable television provider, a satellite television provider, or an Internet-based television provider. In the example illustrated in FIG. 3, television service provider site 306 includes service distribution engine 308 and database 310. Service distribution engine 308 may be configured to receive data, including, for example, multimedia content, interactive applications, and messages, and distribute data to receiver devices 302A-302N through television service network 304. For example, service distribution engine 308 may be configured to transmit television services according to aspects of the one or more of the transmission standards described above (e.g., an ATSC standard). In one example, service distribution engine 308 may be configured to receive data from one or more sources. For example, television service provider site 306 may be configured to receive a transmission including television programming through a satellite uplink/downlink. Further, as illustrated in FIG. 3, television service provider site 306 may be in communication with wide area network 312 and may be configured to receive data from content provider sites 314A-314N and further receive data from data provider sites 316A-316N. It should be noted that in some examples, television service provider site 306 may include a television studio and content may originate therefrom.

Database 310 may include storage devices configured to store data including, for example, multimedia content and data associated therewith, including for example, descriptive data and executable interactive applications. For example, a sporting event may be associated with an interactive application that provides statistical updates. Data associated with multimedia content may be formatted according to a defined data format, such as, for example, HTML, Dynamic HTML, XML, and JSON, and may include Universal Resource Locators (URLs) and Universal Resource Identifiers (URIs) enabling receiver devices 302A-302N to access data, e.g., from one of data provider sites 316A-316N. In some examples, television service provider site 306 may be configured to provide access to stored multimedia content and distribute multimedia content to one or more of receiver devices 302A-302N through television service network 304. For example, multimedia content (e.g., music, movies, and television (TV) shows) stored in database 310 may be provided to a user via television service network 304 on a so-called on demand basis.

Wide area network 312 may include a packet based network and operate according to a combination of one or more telecommunication protocols. Telecommunications protocols may include proprietary aspects and/or may include standardized telecommunication protocols. Examples of standardized telecommunications protocols include Global System Mobile Communications (GSM) standards, code division multiple access (CDMA) standards, 3rd Generation Partnership Project (3GPP) standards, European Telecommunications Standards Institute (ETSI) standards, European standards (EN), IP standards, Wireless Application Protocol (WAP) standards, and Institute of Electrical and Electronics Engineers (IEEE) standards, such as, for example, one or more of the IEEE 802 standards (e.g., Wi-Fi). Wide area network 312 may comprise any combination of wireless and/or wired communication media. Wide area network 312 may include coaxial cables, fiber optic cables, twisted pair cables, Ethernet cables, wireless transmitters and receivers, routers, switches, repeaters, base stations, or any other equipment that may be useful to facilitate communications between various devices and sites. In one example, wide area network 312 may include the Internet.

Referring again to FIG. 3, content provider sites 314A-314N represent examples of sites that may provide multimedia content to television service provider site 306 and/or receiver devices 302A-302N. For example, a content provider site may include a studio having one or more studio content servers configured to provide multimedia files and/or streams to television service provider site 306. In one example, content provider sites 314A-314N may be configured to provide multimedia content using the IP suite. For example, a content provider site may be configured to provide multimedia content to a receiver device according to Real Time Protocol (RTP), Real Time Streaming Protocol (RTSP), or HTTP (Hypertext Transfer Protocol).

Data provider sites 316A-316N may be configured to provide data, including hypertext based content, and the like, to one or more of receiver devices 302A-302N and/or television service provider site 306 through wide area network 312. A data provider site 316A-316N may include one or more web servers. Data provided by data provider sites 316A-316N may be defined according to data formats, such as, for example, HTML, Dynamic HTML, XML, and JSON. An example of a data provider site includes the United States Patent and Trademark Office website. It should be noted that in some examples, data provided by data provider sites 316A-316N may be utilized for so-called second screen or companion device applications. For example, companion device(s) in communication with a receiver device may display a website in conjunction with television programming being presented on the receiver device. It should be noted that data provided by data provider sites 316A-316N may include audio and video content. As described above, with respect to content delivery protocol model 100, data elements that describe applications may be delivered through HTTP. Thus, in one example, data provider sites 316A-316N may be configured generate data or documents including applications and/or data elements that describe applications according to one or more of the techniques described herein.

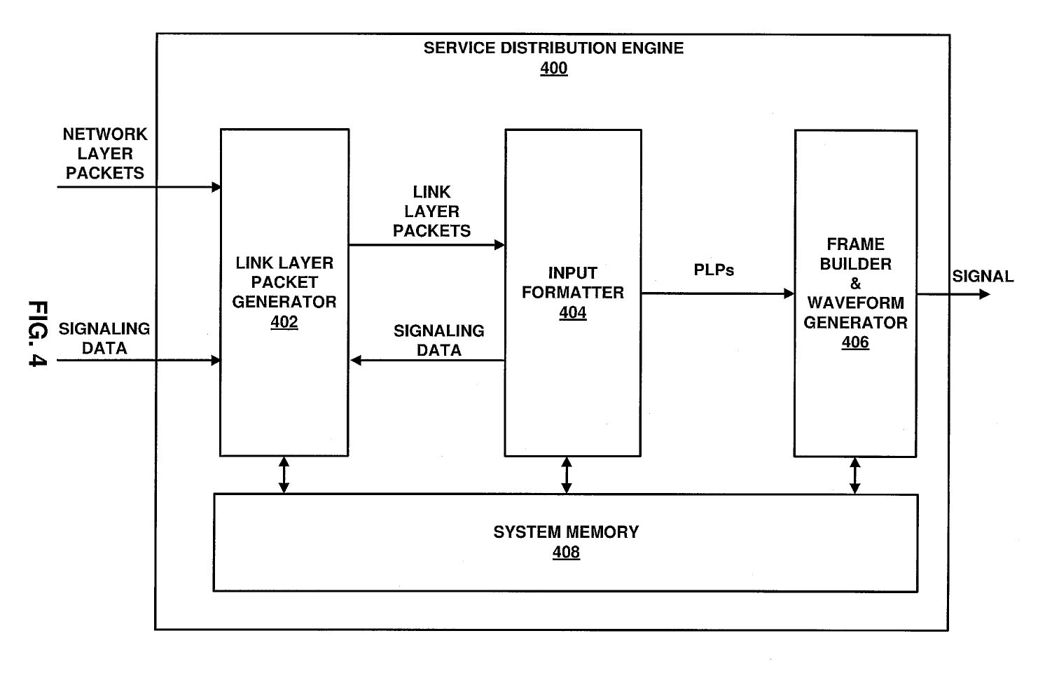

As described above, service distribution engine 308 may be configured to receive data, including, for example, multimedia content, interactive applications, and messages, and distribute data to receiver devices 302A-302N through television service network 304. FIG. 4 is a block diagram illustrating an example of a service distribution engine that may implement one or more techniques of this disclosure. Service distribution engine 400 may be configured to receive data and output a signal representing that data for distribution over a communication network, e.g., television service network 304. For example, service distribution engine 400 may be configured to receive one or more data streams and output a signal that may be transmitted using a single radio frequency band (e.g., a 6 MHz channel, an 8 MHz channel, etc.) or a bonded channel (e.g., two separate 6 MHz channels). A data stream may generally refer to data encapsulated in a set of one or more data packets. In the example illustrated in FIG. 4, service distribution engine 400 is illustrated as receiving data in the form of network layer packets and signaling data. As described above, with respect to Table 1, in some examples, network layer packets may include MPEG-TS packets, IPv4 packets, and the like. It should be noted that in other examples, service distribution engine 400 may receive higher layer data (e.g., a file stored on database 310, etc.) and encapsulate data into network layer packets. As further, described above, signaling data may include session information data.

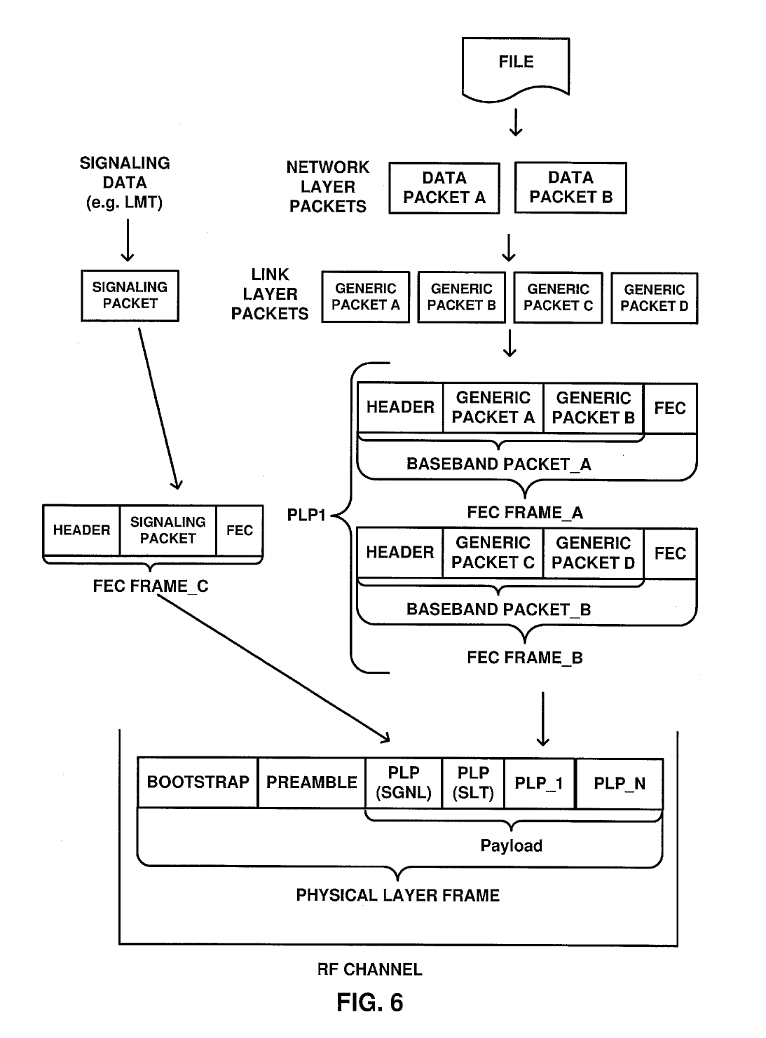

FIG. 6 illustrates an example of how a data file (e.g., a primary video presentation file, a primary audio presentation file, a secondary audio presentation file, an interactive application file, etc.) and signaling data may be output as a signal for distribution over a communication network. In the example illustrated in FIG. 6, a file is encapsulated into network layer packets, i.e., data packet A and data packet B. Examples of types of network layer packets are described above. In the example illustrated in FIG. 6, data packet A and data packet B are encapsulated into link layer packets, i.e., generic packet A, generic packet B, generic packet C, and generic packet D. It should be noted that although, in the example illustrated in FIG. 6, two network layer packets are illustrated as being encapsulated within four link layer packets (i.e., segmentation), in other examples, a number of network layer packets may be encapsulated into a smaller number of link layer packets (i.e., concatenation). For example, multiple network layer packet may be encapsulated into a single link layer packet. Aspects of a link layer packet structure may be defined according to a communications standard. For example, a link layer packet may have a header format and minimum and maximum lengths defined according to a communications standard. Examples of link layer packet structures are described in above with respect to FIGS. 2A-2B.

In the example illustrated in FIG. 6, signaling packet and generic packets are received for physical layer processing. In the example illustrated in FIG. 6, physical layer processing includes encapsulating generic packet A, generic packet B, generic packet C, and generic packet D in respective baseband packets, i.e., Baseband Packet_A and Baseband Packet_B. As illustrated in FIG. 6, baseband packets may be included in FEC (forward error correction) frames. That is, in the example illustrated in FIG. 6, Baseband Packet_A and Baseband Packet_B are respectively encapsulated in FEC Frame_A and FEC Frame_B. In one example, forward error correction information may include an inner code and an outer code. As further illustrated in FIG. 6, signaling packet is encapsulated in FEC Frame_C. As described above, a PLP may include a portion of an RF channel having particular modulation and coding parameters. As illustrated in FIG. 6, FEC frames may be mapped to PLPs. It should be noted that the mapping of FEC frames to PLPs may include one or more interleaving techniques. Bit-interleaving may increase the robustness of data transmission. Examples of bit interleaving techniques, include, parity interleaving, column twist interleaving, group-wise interleaving, and block interleaving.

In the example, illustrated in FIG. 6, the signaling packet (e.g., an LMT) is carried using PLP (SGNL) and generic packet A, generic packet B, generic packet C, and generic packet D (i.e., the file) are carried in PLP_1. Further, in the example illustrated in FIG. 6, the physical layer frame includes PLP_N. As described above, PLPs can carry one or more upper layer sessions. Thus, in one example, PLP_1 may carry one upper layer session and PLP_N may carry another upper layer session. For example, PLP_1 may carry a session including an audio component associated with a primary audio track and PLP_N may carry a session including an audio component associated with a secondary audio track (e.g., secondary language, commentary, etc.). As further illustrated in the example FIG. 6, the physical layer frame includes PLP (SLT). PLP (SLT) represents an example of a PLP carrying a service list table (SLT). A SLT may include information necessary to allow the presentation of a service list that is meaningful to viewers, information that can support initial service selection via channel number or up/down, and/or information necessary to locate signaling which provides information for discovery and acquisition of services and their content components for each service listed. For example, an SLT may indicate that PLP_1 carries a session including an audio component associated with a primary audio track and that PLP_N carries a session including an audio component associated with a secondary audio track. As described above, in some cases, it may be useful for a receiver device to be able to obtain session identifying information through link layer signaling. It should be noted that the ATSC 3.0 proposed link layer enables link layer signaling to be obtained earlier than signaling used to provide information included in an SLT. It should be noted that in some example system implementations, it may be required that a signaling packet (e.g., FEC FRAME_C) and service list table are included in a same PLP or otherwise collocated. This may enable a receiver device to obtain service list information and identify PLPs that included those services more efficiently.

Referring again to FIG. 4, as illustrated in FIG. 4, service distribution engine 400 includes link layer packet generator 402, input formatter 404, frame builder and waveform generator 406, and system memory 408. Each of link layer packet generator 402, input formatter 404, frame builder and waveform generator 406, and system memory 408 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although service distribution engine 400 is illustrated as having distinct functional blocks, such an illustration is for descriptive purposes and does not limit service distribution engine 400 to a particular hardware architecture. Functions of service distribution engine 400 may be realized using any combination of hardware, firmware and/or software implementations.

System memory 408 may be described as a non-transitory or tangible computer-readable storage medium. In some examples, system memory 408 may provide temporary and/or long-term storage. In some examples, system memory 408 or portions thereof may be described as non-volatile memory and in other examples portions of system memory 408 may be described as volatile memory. Examples of volatile memories include random access memories (RAM), dynamic random access memories (DRAM), and static random access memories (SRAM). Examples of non-volatile memories include magnetic hard discs, optical discs, floppy discs, flash memories, or forms of electrically programmable memories (EPROM) or electrically erasable and programmable (EEPROM) memories. System memory 408 may be configured to store information that may be used by service distribution engine 400 during operation. It should be noted that system memory 408 may include individual memory elements included within each of link layer packet generator 402, input formatter 404, and frame builder and waveform generator 406. For example, system memory 408 may include one or more buffers (e.g., First-in First-out (FIFO) buffers) configured to store data for processing by a component of service distribution engine 400.

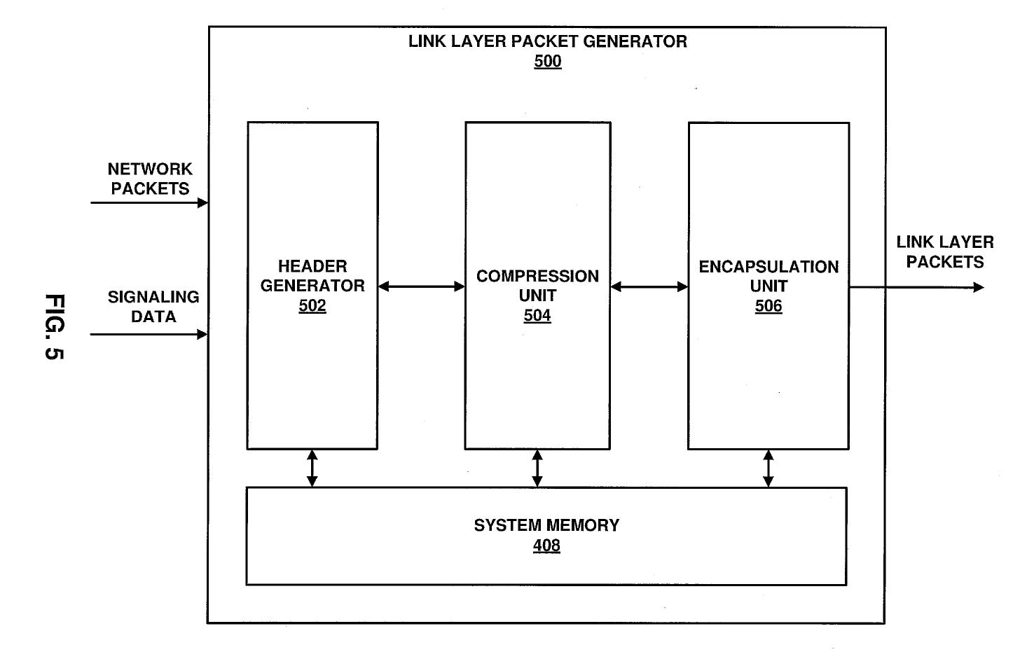

Link layer packet generator 402 may be configured to receive network packets and generate packets according to a defined link layer packet structure. For example, link layer packet generator 402 may be configured to receive network packets and/or signaling data and generate packets according to the example link layer packet structures described below with respect to FIGS. 2A-2B. An example of a link layer packet generator is described in further detail below with respect to FIG. 5. Input formatter 404 may be configured to receive data, including data corresponding to multimedia content and define a PLP. Input formatter 404 may be configured to define a PLP structure for a set of received generic packets, (i.e., any of several types of link layer packets) corresponding to a data stream. In one example, input formatter 404 may be configured to determine how a set of link layer packets corresponding to a data stream will be encapsulated in one or more baseband frames. In some examples, a baseband frame may be a fixed length (e.g., defined according to a communications standard) and may include a header and a payload including generic packets. As illustrated in FIG. 4, input formatter 404 may provide signaling data to link layer packet generator 402. That is, for example, input formatter 404 may indicate a PLP structure and link layer packet generator 402 may generate signaling link layer packets based on the PLP structure.

Frame builder and waveform generator 406 may be configured to receive data or the like associated with one or more logical PLPs (e.g., one or more FEC frames) and may map the data to a frame structure within an RF channel. Mapping may include one more interleaving techniques and/or one or more modulation techniques, including, for example, orthogonal frequency-division multiplexing (OFDM), Quadrature Phase Shift Keying (QPSK) and Quadrature Amplitude Modulation (QAM) schemes (e.g., 16QAM, 64QAM, 256-QAM, 1024QAM, and 4096QAM). A frame carrying one or more PLPs may be referred to as a physical layer frame (PHY-Layer frame). In one example, a frame structure may include a bootstrap, a preamble, and a data payload including one or more PLPs. A bootstrap may act as a universal entry point for a waveform. A preamble may include so-called Layer-1 signaling (L1-signaling). L1-signaling may provide the necessary information to configure physical layer parameters. In one example, frame builder and waveform generator 406 may be configured to use OFDM symbols to produce a signal for transmission within one or more of types of RF channels: a single 6 MHz channel, a single 7 MHz channel, single 8 MHz channel, a single 11 MHz channel, and bonded channels including any two or more separate single channels (e.g., a 14 MHz channel including a 6 MHz channel and a 8 MHz channel). Further, in one example, frame builder and waveform generator 406 may be configured to support layer division multiplexing. Layer division multiplexing may refer to super-imposing multiple layers of data on the same RF channel (e.g., a 6 MHz channel). Typically, an upper layer refers to a core (e.g., more robust) layer supporting a primary service and a lower layer refers to a high data rate layer supporting enhanced services. For example, an upper layer could support basic High Definition video content and a lower layer could support enhanced Ultra-High Definition video content.

As described above, link layer packet generator 402 may be configured to receive network packets and generate packets according to a defined link layer packet structure. FIG. 5 is a block diagram illustrating an example of a link layer packet generator that may implement one or more techniques of this disclosure. As illustrated in FIG. 5, link layer packet generator 500 includes header generator 502, compression unit 504, and encapsulation unit 506. Each of header generator 502, compression unit 504, and encapsulation unit 506 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although link layer packet generator 500 is illustrated as having distinct functional blocks, such an illustration is for descriptive purposes and does not limit link layer packet generator 500 to a particular hardware architecture. Functions of link layer packet generator 500 may be realized using any combination of hardware, firmware and/or software implementations.

Header generator 502 may be configured to generate a header for a link layer packet based on received network layer packets or signaling data. Compression unit 504 may be configured to apply one or more data reduction and/or compression techniques to optimize a link layer payload size. For example, compression unit 504 may be configured to apply the MPEG-TS and/or IP header compression techniques described above. Encapsulation unit 506 may be configured to encapsulate data included in received network layer packets. In some examples, encapsulation unit 506 may be configured to encapsulate data based one or more data reduction and/or compression techniques.

Further, as described above, LMTs may provide session identifying information. Encapsulation unit 506 may be configured to generate an LMT providing session information according to the example LMT syntax provided in Table 8. It should be noted that with respect to Table 8, syntax elements SID_flag, compressed_flag, and SID may be based on the definitions provided above with respect to Table 7A and for the sake of brevity are not repeated with respect to Table 8.

TABLE 8

| | | |
|---|---|---|
| | No. of | |
| Syntax | bits | Format |

link_mapping_table( ) {

| | | |
|---|---|---|
| PLP_ID_map | 64 | uimsbf |
| for(i=0;i<64;i++) { | | |
| if(PLP_ID_map[i]==’1’) { | | |
| num_session | 8 | uimsbf |
| for(j=0; j<num_ session; j++) { | | |

| | | |
|---|---|---|
| src_IP_add | 32 | uimsbf |
| dst_IP_add | 32 | uimsbf |
| src_UDP_port | 16 | uimsbf |
| dst_UDP_port | 16 | uimsbf |
| SID_flag | 1 | bslbf |
| compressed_flag | 1 | bslbf |
| reserved | 6 | ‘111111’ |
| if (SID_flag ==″1″) { | | |

| | | |
|---|---|---|
| SID | 8 | uimsbf |

}
if (compressed_flag == “1”) {

| | | |
|---|---|---|
| context_id | 8 | uimsbf |

}

}

}// if
}// for

}

In the example illustrated in Table 8, link mapping table( ) includes a PLP identifier map (signaled as syntax element PLP_ID_map). As described above, with respect to Tables 7A, a PLP identifier may include a 6-bit syntax element, and as such a PLP may be identified using one of 64 possible values (e.g., 0-63). PLP identifier map may identify particular PLPs for which the LMT includes session identifying information. In the example illustrated in Table 8, for each of the possible 64 values of a 6-bit a PLP identifier, a PLP identifier map may provide a bit mask to indicate whether the LMT includes session identifying information for a particular PLP. In this manner, a maximum of 64 bits may be used to identify particular PLPs for which the LMT includes session identifying information regardless of the number of PLPs for which the LMT includes session identifying information. In comparison to the example described above with respect to Table 7B, the example syntax illustrated in Table 8 may provide a bit-savings when the LMT includes session identifying information for at least 8 PLPs. Also, with respect to Table 7B, the same number of bits are required for Table 8 when the LMT includes session identifying information for 7 PLPs. Thus, in general if an LMT is associated with N PLPs then (N−7) bytes may be saved using the syntax in Table 8 compared to syntax in Table 7B. Further, the example syntax illustrated in Table 8 may additionally allow a receiver device to determine whether the LMT includes session identifying information for particular PLP by parsing fewer bits. That is, receiver device can determine whether a particular PLP is identified by parsing the i-th bit of PLP_ID map and without attempting to match a particular PLP_ID value to one of several potential PLP_ID values including in Table 7B.

Examples of definitions of syntax elements, PLP_ID map, num_session, src_IP_add, dst_IP_add, src_UDP_port, dst_UDP_port, and context_id for the syntax provided in Table 8, are provided below. It should be noted with respect to PLP_ID map, in some examples PLP_ID map may be constrained such that PLP_ID_map[i] shall be equal to 1 for at least one value of i.
PLP_ID_map—This 64-bit field shall indicate a bit mask information about PLPs for which link mapping information is included in this Link Mapping Table. A value of 1 for i'th most significant bit indicates that the link mapping information is included for the PLP with PLP ID equal to i in this Link Mapping Table. A value of 0 for i'th most significant bit indicates that the link mapping information is not included for the PLP with PLP_ID equal to I in this Link Mapping Table.

In another example instead of most significant bit semantics PLP_ID_map could be defined for least significant bits as follows:
PLP_ID_map—This 64-bit field shall indicate a bit mask information about PLPs for which link mapping information is included in this Link Mapping Table. A value of 1 for i'th least significant bit indicates that the link mapping information is included for the PLP with PLP ID equal to i in this Link Mapping Table. A value of 0 for i'th least significant bit indicates that the link mapping information is not included for the PLP with PLP_ID equal to i in this Link Mapping Table.
num_session—This 8-bit unsigned integer field shall provide the number of upper layer sessions carried in the PLP with PLP_ID value equal to i. This field shall indicate the number of UDP/IPv4 sessions in the PLP with PLP_ID value equal to i.
src_IP_add—This 32-bit unsigned integer field shall contain the source IPv4 address of an upper layer session carried in the PLP with PLP_ID value equal to i.
dst_IP_add—This 32-bit unsigned integer field shall contain the destination IPv4 address of an upper layer session carried in the PLP with PLP_ID value equal to i.
src_UDP_port—This 16-bit unsigned integer field shall represent the source UDP port number of an upper layer session carried in the PLP with PLP_ID value equal to i.
dst_UDP_port—This 16-bit unsigned integer field shall represent the destination UDP port number of an upper layer session carried in the PLP with PLP_ID value equal to i.
context_id—This 8-bit unsigned integer field shall provide a reference for the context_id (CID) provided in the ROHC-U description table, with value of PLP_ID field in the ROHC-U_description_table( ) equal to i. This field shall be present only when the value of compressed_flag is equal to ‘1’.

Also, it may be required in some examples that when compressed_flag is equal to “1” there shall be a ROHC-U_description_table( ) signaled which has PLP_ID value equal to the PLP_ID value equal to i. In another variant semantics of context_id may be as follows:
context_id—This 8-bit unsigned integer field shall provide a reference for the context id (CID) provided in the ROHC-U_description_table as specified in Section 7.1.2 [of A/330] with value of PLP_ID field in the ROHC-U_description_table( ) equal to PLP_ID which carries this link mapping table. This field shall be present only when the value of compressed_flag is equal to ‘1’.

In this case, the PLP_ID value of the PLP carrying this LMT is used for association to ROHC-U_description_table( ).

Further, in one example, encapsulation unit 506 may be configured to generate an LMT providing session information according to the example LMT syntax provided in Table 9. It should be noted that with respect to Table 9, 6-bit syntax element num_PLPs may indicate the number of PLPs for which session identifying information is provided in the LMT. In one example, num_PLPs may be constrained to not be equal to 0. Further, in one example, the number of PLPs for which link mapping information is provided in the LMT may be signaled using a syntax element that provides a value that is one greater than the number of PLPs for which link mapping information is provided (i.e., minus 1 coding may be used, e.g., a syntax element num_PLPs_minus1 may be used).

In Table 9, each of PLP_ID, num_session, src_IP_add, dst_IP_add, src_UDP_port, dst_UDP_port, SID_flag, compressed_flag, SID, and context_id may be based on the definitions provided above with respect to Tables 7A-7B and for the sake of brevity are not repeated with respect to Table 9. However, it should be noted that each of the definitions of num_session, src_IP_add, dst_IP_add, src_UDP_port, dst_UDP_port, SID_flag, compressed_flag, SID, and context_id may be modified such that each instance thereof corresponds to an i'th instance of a PLP_ID. Further, it should be noted that with respect to Table 8 and Table 9, in some examples, a constraint may be applied such that when compressed_flag is equal to ‘1’ a ROHC-U_description_table( ) shall be signaled which has PLP_ID corresponding to a PLP_ID value indicated by PLP_ID_map[i] in Table 8 or the i-th PLP_ID in Table 9. In some instances a receiver device may be configured to determine that an error has occurred when a ROHC-U_description_table( ) having a PLP_ID corresponding to a PLP_ID value indicated by PLP_ID_map[i] in Table 8 or the i-th PLP_ID in Table 9 is not received.

TABLE 9

| | | |
|---|---|---|
| | No. of | |
| Syntax | bits | Format |

link_mapping_table( ) {

| | | |
|---|---|---|
| num_PLPs | 6 | uimsbf |
| reserved | 2 | ‘11’ |
| for(i=0;i<num_PLPs;i++) { | | |

| | | |
|---|---|---|
| PLP_ID | 6 | uimsbf |
| reserved | 2 | ‘11’ |

}
for(i=0;i<num_PLPs;i++) {

| | | |
|---|---|---|
| num_session | 8 | uimsbf |
| for(j=0; j<num_ session; j++) { | | |

| | | |
|---|---|---|
| src_IP_add | 32 | uimsbf |
| dst_IP_add | 32 | uimsbf |
| src_UDP_port | 16 | uimsbf |
| dst_UDP_port | 16 | uimsbf |
| SID_flag | 1 | bslbf |
| compressed_flag | 1 | bslbf |
| reserved | 6 | ‘111111’ |
| if (SID_flag ==″1″) { | | |

| | | |
|---|---|---|
| SID | 8 | uimsbf |

}
if (compressed_flag == “1”)

{

| | | |
|---|---|---|
| context_id | 8 | uimsbf |

}

}

}

}

It should be noted with respect to Table 9, that the example syntax provides a first for loop that identifies particular PLPs for which link mapping information is provided in the LMT and uses a second for loop to provide session identifying information for each of the particular PLPs. In this manner, if a receiver device is attempting to obtain session identifying information for a particular PLP from the LMT, the receiver device may parse the first for loop to determine if the LMT includes session identifying information for the particular PLP. In this manner, a receiver device may parse the first for loop to determine if whether to parse the remaining portion of a packet include the link mapping table. For example, if a receiver device is not attempting to obtain session identifying information for PLPs identified in the first for loop, the receiver device may cease parsing the remaining payload since overall packet length is provide in length field 228.

Further, it should be noted with respect to Table 8 and Table 9, in contrast to Tables 7A-7B, Table 8 and Table 9 do not include syntax element signaling_type. That is, in some examples, a receiver device may be configured to determine the value of signaling_type from signaling type field 252 described above. Thus, for example, syntax element signaling_type may not be signaled in Table 7B. Further, in some examples, a value of signaling_type may be signaled based on the example syntax for a link layer packet illustrated in Table 10.

TABLE 10

| | | Number of | |
|---|---|---|---|
| Syntax | | bits | Format |
| Link_layer_Packet_Header( ) {...} | | var | Table 2 |
| Link_layer_Packet_Payload( ){ | | | |
| | if( signaling_type==‘0x01’ ) { | | |
| | link_mapping_table( ) | var | Table 7A, Table |
| | | | 7B, Table 8, or |
| | | | Table 9 |
| | } | | |
| | else if( signaling_type==‘0x02’ ) | | |
| | ROHC-U_description_table( ) | var | Sec 7.1.2 of A330 |
| | } | | |
| | else { | | |
| | reserved | x | |
| | } | | |

}

With respect to Table 10, in one example, the check if(signaling_type==‘0x01’) condition may be modified to use a check (if(signaling_type==‘0x01’) && (packet_type==‘100’) condition. Further, with respect to Table 10, in one example, the check if(signaling_type==‘0x02’) condition may be modified to use a check (if(signaling_type==‘0x02’) && (packet_type==‘100’) condition. Thus, in some examples, the syntax in Table 10 may only apply to packets of having a packet_type indicating link layer signaling as provide in Table 1.

In another example, variant Table 10 may be modified as illustrated in Table 11.

TABLE 11

| | Number of | |
|---|---|---|
| Syntax | bits | Format |
| Link_layer_Packet_Header( ) {...} | var | Table 2 |
| Link_layer_Packet_Payload( ) { | | |

if( packet_type==‘100’) {

if( signaling_type==‘0x01’ ) {

| | | |
|---|---|---|
| link_mapping_table( ) | var | Table 7A, Table |

7B, Table 8, or
Table 9

}
else if( signaling_type==‘0x02’ )

| | | |
|---|---|---|
| ROHC-U_description_table( ) | var | Sec 7.1.2 of A330 |

}
else {

| | |
|---|---|
| reserved | x |

}

}

else if(Packet_Type=‘110’) {

| | |
|---|---|
| reserved | x |

}

else {

| | |
|---|---|
| reserved | x |

}

}

Further, it should be noted as described above, signaling version field 255 may be used to indicate whether a LMT has been updated in a subsequent transmission. In the case of A/330, where a LMT corresponds to a single PLP, signaling version field 255 may indicate whether session identification information associated with the single particular PLP has been updated.

In the case of the examples Table 8 and Table 9, where an LMT may provide session identification information associated with a plurality of PLPs, if may be useful to signal one or more particular types of updates. For example, an update to an LMT including session identification information associated with a plurality of PLPs may include an update to session identification information associated with a particular one of the plurality of PLPs, an update to include session identification information for additional PLPs, and/or combination thereof. As described above, in some cases, a receiver device may attempt to obtain session identifying information for a particular PLP. In this manner, in order for a receiver device to obtain updates to session identifying information for a particular PLP through a LMT including session identification information associated with a plurality of PLPs. A signaling_version syntax element may be defined as follows:
signaling_version—This 8-bit field shall indicate the version of signaling. The value of this field shall be incremented by 1 whenever any data of the signaling identified by signaling_type changes. The value of signaling_version field shall wrap around to 0 after its maximum value. When signaling_type is equal to 0x01 the scope of this field is associated with link mapping table which has the same value for PLP_ID_map field. When signaling_type is equal to 0x01 the value of this field shall be incremented by 1 whenever any data in the link mapping table with the same value for signaling_type and PLP_ID_map fields changes.

In this example, signaling version field 255 may indicate whether a LMT includes an update to session identifying information for a particular PLP within a set of PLPs. In this manner, service distribution engine 400 represents an example of a device configured to transmit data associated with an upper layer session according to one or more link layer packet payload structures defined according to one or more techniques of this disclosure.

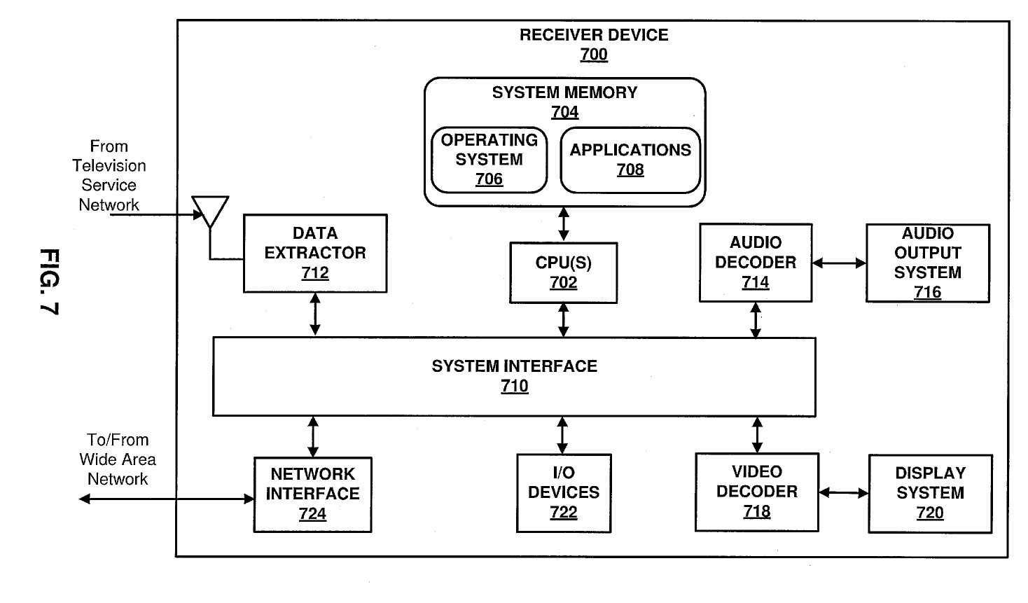

FIG. 7 is a block diagram illustrating an example of a receiver device that may implement one or more techniques of this disclosure. Receiver device 700 is an example of a computing device that may be configured to receive data from a communications network and allow a user to access multimedia content. In the example illustrated in FIG. 7, receiver device 700 is configured to receive data via a television network, such as, for example, television service network 304 described above. Further, in the example illustrated in FIG. 7, receiver device 700 is configured to send and receive data via a wide area network. It should be noted that in other examples, receiver device 700 may be configured to simply receive data through a television service network 304. The techniques described herein may be utilized by devices configured to communicate using any and all combinations of communications networks.

As illustrated in FIG. 7, receiver device 700 includes central processing unit(s) 702, system memory 704, system interface 710, data extractor 712, audio decoder 714, audio output system 716, video decoder 718, display system 720, I/O device(s) 722, and network interface 724. As illustrated in FIG. 7, system memory 704 includes operating system 706 and applications 708. Each of central processing unit(s) 702, system memory 704, system interface 710, data extractor 712, audio decoder 714, audio output system 716, video decoder 718, display system 720, I/O device(s) 722, and network interface 724 may be interconnected (physically, communicatively, and/or operatively) for inter-component communications and may be implemented as any of a variety of suitable circuitry, such as one or more microprocessors, digital signal processors (DSPs), application specific integrated circuits (ASICs), field programmable gate arrays (FPGAs), discrete logic, software, hardware, firmware or any combinations thereof. It should be noted that although receiver device 700 is illustrated as having distinct functional blocks, such an illustration is for descriptive purposes and does not limit receiver device 700 to a particular hardware architecture. Functions of receiver device 700 may be realized using any combination of hardware, firmware and/or software implementations.

CPU(s) 702 may be configured to implement functionality and/or process instructions for execution in receiver device 700. CPU(s) 702 may include single and/or multi-core central processing units. CPU(s) 702 may be capable of retrieving and processing instructions, code, and/or data structures for implementing one or more of the techniques described herein. Instructions may be stored on a computer readable medium, such as system memory 704.

System memory 704 may be described as a non-transitory or tangible computer-readable storage medium. In some examples, system memory 704 may provide temporary and/or long-term storage. In some examples, system memory 704 or portions thereof may be described as non-volatile memory and in other examples portions of system memory 704 may be described as volatile memory. System memory 704 may be configured to store information that may be used by receiver device 700 during operation. System memory 704 may be used to store program instructions for execution by CPU(s) 702 and may be used by programs running on receiver device 700 to temporarily store information during program execution. Further, in the example where receiver device 700 is included as part of a digital video recorder, system memory 704 may be configured to store numerous video files.

Applications 708 may include applications implemented within or executed by receiver device 700 and may be implemented or contained within, operable by, executed by, and/or be operatively/communicatively coupled to components of receiver device 700. Applications 708 may include instructions that may cause CPU(s) 702 of receiver device 700 to perform particular functions. Applications 708 may include algorithms which are expressed in computer programming statements, such as, for-loops, while-loops, if-statements, do-loops, etc. Applications 708 may be developed using a specified programming language. Examples of programming languages include, Java™, Jini™, C, C++, Objective C, Swift, Perl, Python, PhP, UNIX Shell, Visual Basic, and Visual Basic Script. In the example where receiver device 700 includes a smart television, applications may be developed by a television manufacturer or a broadcaster. As illustrated in FIG. 7, applications 708 may execute in conjunction with operating system 706. That is, operating system 706 may be configured to facilitate the interaction of applications 708 with CPUs(s) 702, and other hardware components of receiver device 700. Operating system 706 may be an operating system designed to be installed on set-top boxes, digital video recorders, televisions, and the like. It should be noted that techniques described herein may be utilized by devices configured to operate using any and all combinations of software architectures.

System interface 710 may be configured to enable communications between components of receiver device 700. In one example, system interface 710 comprises structures that enable data to be transferred from one peer device to another peer device or to a storage medium. For example, system interface 710 may include a chipset supporting Accelerated Graphics Port (AGP) based protocols, Peripheral Component Interconnect (PCI) bus based protocols, such as, for example, the PCI Express™ (PCIe) bus specification, which is maintained by the Peripheral Component Interconnect Special Interest Group, or any other form of structure that may be used to interconnect peer devices (e.g., proprietary bus protocols).

As described above, receiver device 700 is configured to receive and, optionally, send data via a television service network. As described above, a television service network may operate according to a telecommunications standard. A telecommunications standard may define communication properties (e.g., protocol layers), such as, for example, physical signaling, addressing, channel access control, packet properties, and data processing. In the example illustrated in FIG. 7, data extractor 712 may be configured to extract video, audio, and data from a signal. A signal may be defined according to, for example, aspects DVB standards, ATSC standards, ISDB standards, DTMB standards, DMB standards, and DOCSIS standards.

Data extractor 712 may be configured to extract video, audio, and data, from a signal generated by service distribution engine 400 described above. That is, data extractor 712 may operate in a reciprocal manner to service distribution engine 400. Further, data extractor 712 may be configured to parse link layer packets based on any combination of one or more of the structures described above.

Data packets may be processed by CPU(s) 702, audio decoder 714, and video decoder 718. Audio decoder 714 may be configured to receive and process audio packets. For example, audio decoder 714 may include a combination of hardware and software configured to implement aspects of an audio codec. That is, audio decoder 714 may be configured to receive audio packets and provide audio data to audio output system 716 for rendering. Audio data may be coded using multi-channel formats such as those developed by Dolby and Digital Theater Systems. Audio data may be coded using an audio compression format. Examples of audio compression formats include Motion Picture Experts Group (MPEG) formats, Advanced Audio Coding (AAC) formats, DTS-HD formats, and Dolby Digital (AC-3) formats. Audio output system 716 may be configured to render audio data. For example, audio output system 716 may include an audio processor, a digital-to-analog converter, an amplifier, and a speaker system. A speaker system may include any of a variety of speaker systems, such as headphones, an integrated stereo speaker system, a multi-speaker system, or a surround sound system.

Video decoder 718 may be configured to receive and process video packets. For example, video decoder 718 may include a combination of hardware and software used to implement aspects of a video codec. In one example, video decoder 718 may be configured to decode video data encoded according to any number of video compression standards, such as ITU-T H.262 or ISO/IEC MPEG-2 Visual, ISO/IEC MPEG-4 Visual, ITU-T H.264 (also known as ISO/IEC MPEG-4 AVC), and High-Efficiency Video Coding (HEVC). Display system 720 may be configured to retrieve and process video data for display. For example, display system 720 may receive pixel data from video decoder 718 and output data for visual presentation. Further, display system 720 may be configured to output graphics in conjunction with video data, e.g., graphical user interfaces. Display system 720 may comprise one of a variety of display devices such as a liquid crystal display (LCD), a plasma display, an organic light emitting diode (OLED) display, or another type of display device capable of presenting video data to a user. A display device may be configured to display standard definition content, high definition content, or ultra-high definition content.

I/O device(s) 722 may be configured to receive input and provide output during operation of receiver device 700. That is, I/O device(s) 722 may enable a user to select multimedia content to be rendered. Input may be generated from an input device, such as, for example, a push-button remote control, a device including a touch-sensitive screen, a motion-based input device, an audio-based input device, or any other type of device configured to receive user input. I/O device(s) 722 may be operatively coupled to receiver device 700 using a standardized communication protocol, such as for example, Universal Serial Bus protocol (USB), Bluetooth, ZigBee or a proprietary communications protocol, such as, for example, a proprietary infrared communications protocol.

Network interface 724 may be configured to enable receiver device 700 to send and receive data via a local area network and/or a wide area network. Network interface 724 may include a network interface card, such as an Ethernet card, an optical transceiver, a radio frequency transceiver, or any other type of device configured to send and receive information. Network interface 724 may be configured to perform physical signaling, addressing, and channel access control according to the physical and Media Access Control (MAC) layers utilized in a network. Further, network interface 724 may include a link layer packet generator, such as for example, link layer packet generator 500 described above. Further, network interface 724 may be configured to parse link layer packet based on any combination of one or more of the structures described above.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array signal (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

Various examples have been described. These and other examples are within the scope of the following claims.

1: A method for signaling upper layer information in a link layer packet, the method comprising:
generating a table including session identifying information respectively associated with one or more physical layer pipes, wherein the first syntax element in the table is a 6-bit syntax element indicating the number of physical layer pipes minus one for which session identifying information is provided; and
transmitting the table to one or more receiver devices.

2: The method of claim 1, wherein the table includes respective physical layer pipe identifier values for the indicated number of physical layer pipes.

3: The method of claim 2, wherein a session includes data associated with a network address.

4: The method of claim 2, wherein session identifying information includes one or more of a source address, a destination address, a source port and a destination port.

5: The method of claim 4, wherein session identifying information includes an indication of whether header compression is applied to packets carrying the identified session and further comprising generating a table including compression description information when header compression is applied, wherein the table includes a syntax element having a physical layer pipe identifier value equal to the physical layer pipe identifier value for the physical layer pipe carrying the identified session, and transmitting the table including compression description information to one or more receiver devices.

6: The method of claim 1, wherein transmitting the table to one or more receiver devices includes encapsulating the table in a payload of link layer packet.

7: The method of claim 6, wherein the link layer packet includes a link layer signaling packet type.

8: A device comprising one or more processors configured to:
parse a signal including a table including session identifying information respectively associated with one or more physical layer pipes, wherein the table includes a 6-bit syntax element as a first syntax element; and
determine the number of physical layer pipes for which session identifying information is provided as one less than the value of the 6-bit syntax element.

9: The device of claim 8, wherein the table includes respective physical layer pipe identifier values for the indicated number of physical layer pipes.

10: The device of claim 9, wherein a session includes data associated with a network address.

11: The device of claim 9, wherein session identifying information includes one or more of a source address, a destination address, a source port and a destination port.

12: The device of claim 11, wherein session identifying information includes an indication of whether header compression is applied to packets carrying the identified session.

13. (canceled)

14: The device of claim 8, wherein parsing a signal including the table includes parsing the table from a payload of link layer packet.

15: The device of claim 14, wherein the link layer packet includes a link layer signaling packet type.

16: The device of claim 8, wherein the device is selected from the group consisting of: a desktop or laptop computer, a mobile device, a smartphone, a cellular telephone, a personal data assistant (PDA), a television, a tablet device, or a personal gaming device.

17: A method of determining upper layer information for link layer signaling, the method comprising:
parsing a signal including a table including session identifying information respectively associated with one or more physical layer pipes, wherein the table includes a 6-bit syntax element as a first syntax element; and
determining the number of physical layer pipes for which session identifying information is provided as one less than the value of the 6-bit syntax element.

18: The method of claim 17, wherein session identifying information includes one or more of a source address, a destination address, a source port and a destination port.

19: The method of claim 18, wherein session identifying information includes an indication of whether header compression is applied to packets carrying the identified session.

20. (canceled)
